(19) United States
(12) Patent Application Publication
(10) Pub. No.: US 2011/0234709 A1
(43) Pub. Date: Sep. 29, 2011

(54) LIQUID EJECTION HEAD AND LIQUID EJECTING APPARATUS

(75) Inventors: Nozomi Ogawa, Matsumoto-shi (JP); Shunsuke Watanabe, Matsumoto-shi (JP)

(73) Assignee: SEIKO EPSON CORPORATION, Shinjuku-ku (JP)

(21) Appl. No.: 13/071,428

(22) Filed: Mar. 24, 2011

(30) Foreign Application Priority Data
Mar. 26, 2010 (JP) 2010-072428

(51) Int. Cl. B41J 2/045

(52) U.S. Cl. 347/70

(57) ABSTRACT

A liquid ejecting head includes an ink jet recording head body that ejects ink and a head formed of a resin with a reinforcement member integrally molded therein and having a housing, wherein the head includes a groove in which a part of the reinforcement member is exposed to the bottom surface, and a liquid hold that holds ink and is disposed at the lower end of the groove in the vertical direction.

### CROSS-REFERENCES TO RELATED APPLICATIONS

The entire disclosure of Japanese Patent Application No. 2010-72428, filed Mar. 26, 2010 is expressly incorporated herein by reference.

### BACKGROUND

1. Technical Field

The present invention relates to liquid ejecting heads that eject liquid and liquid ejecting apparatuses, and more specifically to ink jet recording heads that eject ink as liquid and ink jet recording apparatuses.

2. Related Art

Liquid ejecting heads are known that eject liquid droplets from nozzles by means of pressure applied to liquid by pressure generating means such as piezoelectric elements and heat generating elements. Such liquid ejecting heads typically include ink jet recording heads (hereinafter referred to as heads) that eject ink droplets from nozzles.

As an example of those heads, a head is known which includes a head body having a nozzle plate in which nozzle orifices are drilled, a flow channel forming plate in which pressure generating chambers that communicate with the nozzle orifices are formed, and pressure generating means that applies pressure to the pressure generating chambers, and a head case which is made of a resin, wherein the head body is held in the head case.

Further, JP-A-2009-51153 discloses a head case in which a metal fitting is embedded. Such a head case is typically formed by insert molding.

When forming a head case by insert molding, the metal fitting to be embedded in the head case needs to be held by the mold while injecting resin into the mold. Therefore, a groove is formed on the finished head case, through which a portion of the metal fitting that had been in contact with the mold is exposed. The interface between the resin and the metal fitting within the groove may serve as a path of the ink ingress, thereby causing a short circuit among the members that constitute the head body, and thus causing a malfunction of the head body.

For example, when such a groove is formed on the outer surface of the head case or the inner surface of the housing for housing the head body in the head case, ink which is leaked out of a flow passage member such as an ink cartridge may flow into the interface between the resin and metal fitting on the outer surface of the head case, and reach the groove in the housing, thereby causing ink to leak into the housing and the head body.

Such a problem may occur not only in the ink jet recording heads that eject ink droplets, but in any liquid ejecting heads that eject other types of droplets. In addition, the above problem may exist not only when a metal fitting is embedded in a head case by insert molding, but also with respect to a head in general in which a metal fitting embedded in a head case is partially exposed to the outside.

### SUMMARY

According to an aspect of the invention, a liquid ejecting head includes a liquid ejecting head body that ejects liquid droplets, and a housing member formed of a resin with a metal member integrally molded therein and having a housing for housing the liquid ejecting head body, the housing member includes a groove formed on the inner surface of the housing of the housing member and in which a part of the metal member is exposed, and a liquid hold that holds liquid and is disposed at the lower end of the groove in the vertical direction.

According to another aspect of the invention, a liquid ejecting apparatus includes the above liquid ejecting head.

### BRIEF DESCRIPTION OF THE DRAWINGS

The invention will be described with reference to the accompanying drawings, wherein like numbers reference like elements.

FIG. 1 is a plan view of a head according to a first embodiment of the present invention.

FIG. 2 is a cross-sectional view taken along the line II-II of FIG. 1.

FIG. 3 is a cross-sectional view taken along the line III-III of FIG. 1.

FIG. 4 is an enlarged plan view of the principal portion of FIG. 1.

FIG. 5 is a cross-sectional view taken along the line V-V of FIG. 4.

FIG. 6 is a schematic structural view of a liquid ejecting apparatus according to the first embodiment of the present invention.

### DESCRIPTION OF EXEMPLARY EMBODIMENTS

The present invention will be described below in detail with reference to embodiments of the present invention.

### First Embodiment

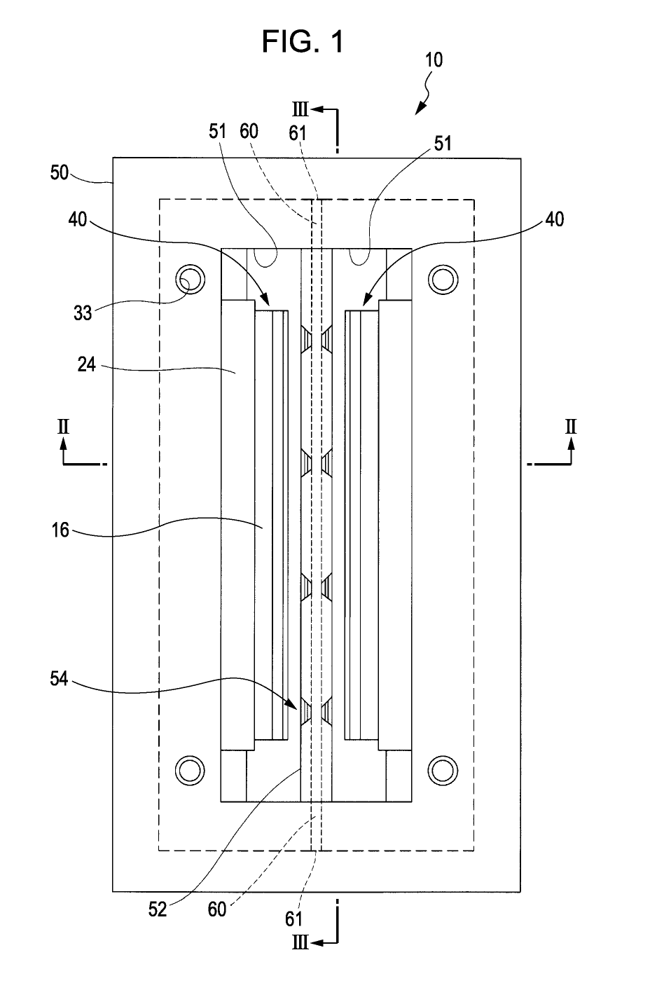

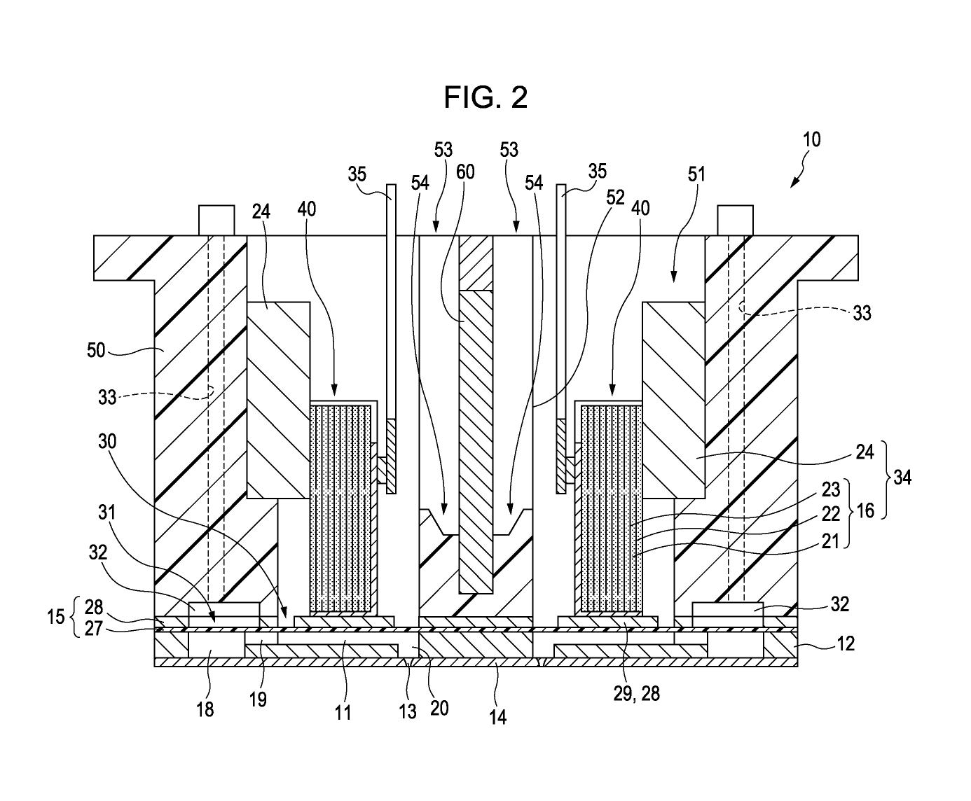

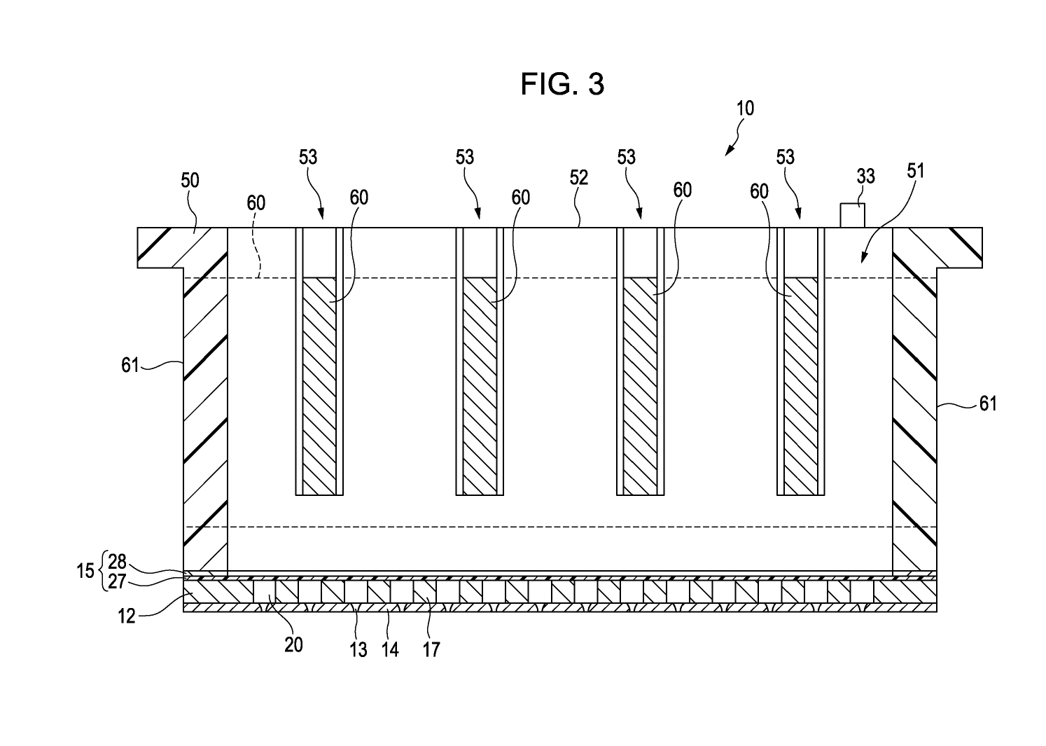

FIG. 1 is a plan view showing an example of an ink jet recording head according to a first embodiment of the present invention. FIG. 2 is a cross-sectional view taken along the line II-II of FIG. 1, and FIG. 3 is a cross-sectional view taken along the line III-III of FIG. 1.

As shown in FIGS. 1 to 3, a head 10 includes a head body 40 and a head case 50 which holds the head body 40.

The head body 40 includes a flow channel forming plate 12 attached to the head case 50 at the lower end surface thereof in the vertical direction and two piezoelectric element units 34 held in a housing 51 that is provided in the head case 50.

The flow channel forming plate 12 is formed of a monocrystalline silicon substrate and has pressure generating chambers 11 arrayed in a surface layer on one side thereof. The pressure generating chambers 11 are separated from each other by a plurality of partitions 17 and arrayed in the width direction (short-side direction) of the flow channel forming plate 12. Manifolds 18 for supplying ink as an example of liquid are allowed to communicate with the pressure generating chambers 11 at one end of the pressure generating chambers 11 in a longitudinal direction via ink supply channels 19. Further, one side of the flow channel forming plate 12 on which orifices for the pressure generating chambers 11 are formed is sealed with a vibration plate 15, while the other side is bonded to a nozzle plate 14 using an adhesive, a thermal adhesive film or the like, wherein the nozzle plate 14 has nozzle orifices 13 drilled therein.

The vibration plate 15 disposed on the flow channel forming plate 12 is made of a composite plate which includes an elastic film 27 formed of an elastic material such as a resin film and a support plate 28 formed of a material such as a metal to support the elastic film 27, with the elastic film 27 side being attached to the flow channel forming plate 12. For example, in this embodiment, the elastic film 27 is made of a PPS (polyphenylene sulfide) film having a thickness in the order of several micrometers, while the support plate 28 is made of a stainless steel material (SUS) having a thickness in the order of several dozen micrometers. Further, islands 29 are disposed on the vibration plate 15 at positions opposite the pressure generating chambers 11 and configured such that distal ends of piezoelectric elements abut upon the islands. That is, on the vibration plate 15, thin walled portions 30 having a reduced thickness relative to the remaining portion are formed at positions opposite the periphery of pressure generating chambers 11, and islands 29 are disposed inside the respective thin walled portions 30. In this embodiment, by disposing the islands 29 on the vibration plate 15, thick walled portions having an increased thickness relative to the remaining portion (thin walled portion 30) are provided.

In addition, compliance portions 31 are provided on the vibration plate 15 at positions opposite the manifolds 18, in a manner similar to that in which the thin walled portions 30 are provided, by etching away the support plate 28, such that the compliance portions 31 are substantially constituted by the elastic film 27. The compliance portions 31 work to absorb the pressure variation in the manifolds 18 by allowing the elastic film 27 at positions of the compliance portions 31 to be deformed in accordance with the pressure variation in order to retain a constant pressure in the manifolds 18.

On the vibration plate 15, a head case 50 is mounted which has ink supply channels 33 as an example of a liquid supply channel that is connected to a plurality of ink cartridges (not shown). Piezoelectric element units 34 are accurately positioned with respect to the head case 50 and secured thereto. Specifically, the head case 50 includes a housing 51 which is formed through the head case 50 in the thickness direction, and each piezoelectric element unit 34 is secured to one side of the inner surface of the housing 51. Further, the distal ends of piezoelectric elements are attached to respective islands 29 (thick walled portion), which are disposed on the vibration plate 15 at positions corresponding to the pressure generating chambers 11, using an adhesive or the like.

Each piezoelectric element unit 34 includes a piezoelectric element forming member 16 in which a plurality of piezoelectric elements are arranged in its width direction, and a fixed plate 24. The piezoelectric element forming member 16 is mounted on the fixed plate 24, such that the distal end (one end) of the piezoelectric element forming member 16 acts as a free end and the proximal end (the other end) is attached to the fixed plate 24 as a fixed end. The piezoelectric element forming member 16 is composed of a piezoelectric material 21 and electrode forming materials 22 and 23, each of which are sequentially layered in a longitudinal direction. In this piezoelectric element unit 34, one side of the fixed plate 24, which is opposite the side where the piezoelectric element forming member 16 is mounted, is secured to the inner surface of the housing 51 in the head case 50.

Moreover, the piezoelectric element unit 34 is connected to a circuit board 35 on which a drive IC (not shown) for driving the piezoelectric elements is mounted. The circuit board 35 is, for example, formed of a COF (chip of film) in this embodiment. Base ends of wires of the circuit board 35 are connected to the electrodes which constitute the piezoelectric elements using solder, an anisotropic conductive material or the like, while the other ends of wires of the circuit board 35 are connected to a wiring substrate (not specifically shown) disposed above the head case 50.

Further, spaces 32 are formed in the head case 50 at positions opposite the compliance portions 31, so as to accommodate the deformation of the compliance portions 31. Each space 32 is allowed to communicate with the outside via a communicating hole (not shown) formed in the head case 50. That is, the space 32 is open to the atmosphere. This allows the compliance portions 31 to be sufficiently deformed in accordance with the pressure variation in the respective manifolds 18.

The head case 50 as described above is formed of a resin. In this embodiment, two housings 51 are provided in the head case 50, wherein each housing 51 is a through hole extending through the head case 50 in the vertical direction, and contains the piezoelectric element unit 34 of the head body 40.

Further, in the head case 50, a reinforcement member 60 as an example of a metal member is integrally molded. Specifically, the reinforcement member 60 (metal member) is embedded in the partition 52 which separates the two housings 51 from each other in the head case 50.

In such a head case 50, the reinforcement member 60 may be integrated (integrally molded) into the head case 50 by inserting the reinforcement member 60 into the mold prior to injecting a resin into the mold for molding the head case 50. As a matter of course, the process in which the reinforcement member is embedded in the head case 50 is not limited to integral molding, but may include forming an embedment hole in the head case 50, and then embedding a reinforcement member 60 in the hole using an adhesive, press fitting or the like.

The reinforcement member is a metal plate-like member which has a longer dimension in the direction that the pressure generating chambers 11 are arrayed. The reinforcement member 60 has a rigidity higher than that of the head case 50. Therefore, the reinforcement member 60 in the partition 52 of the head case 50 enables improvement of the rigidity of the head case 50.

Further, at the outside surface of the head case 50, both end faces 61 of the reinforcement member 60 in the direction that the pressure generating chambers are arrayed are exposed. In this embodiment, the end faces 61 are the portions held by the mold and that had been in contact with the mold during molding of the head case 50. Therefore, the end faces 61 are not coated with a resin and exposed to the outside of the head case 50.

Moreover, in the inner surface of the housing 51 that serves as the partition 52, grooves 53 are formed in which a part of the reinforcement member 60 is exposed to the bottom surface. In this embodiment, the upper side of the groove 53 extends to the top of the partition 52 and the lower side extends to a certain point before reaching the bottom of the partition 52. On each side of the partition 52, four such grooves 53 are formed.

Similar to the end faces 61 that are exposed from the outer surface of the head case 50, the grooves 53 are the portions held by the mold and that had been in contact with the mold during molding of the head case 50. The reinforcement member 60 is supported by the mold so as not to expand or deform under the heat transferred through the resin during integral molding. Thus the grooves 53 are formed.

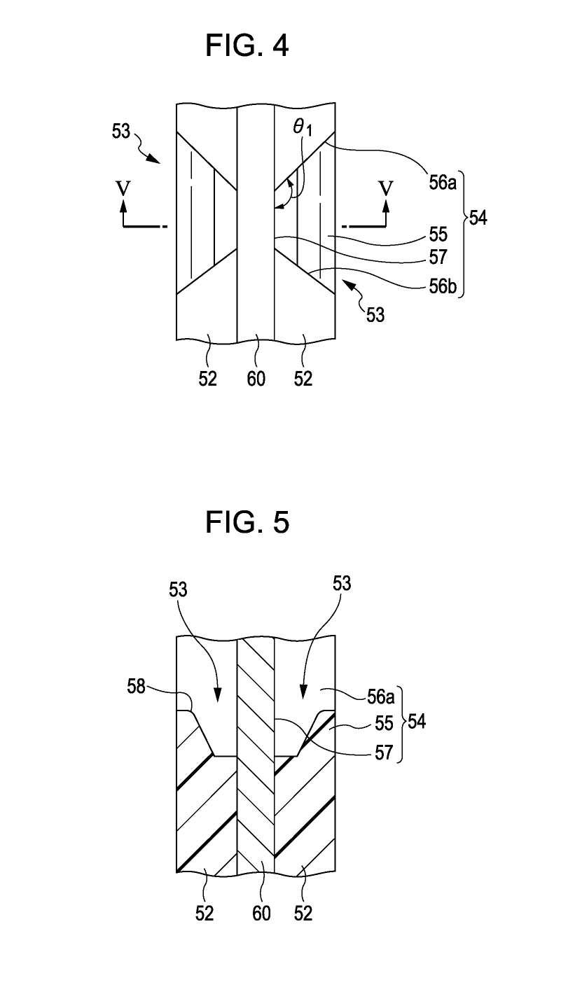

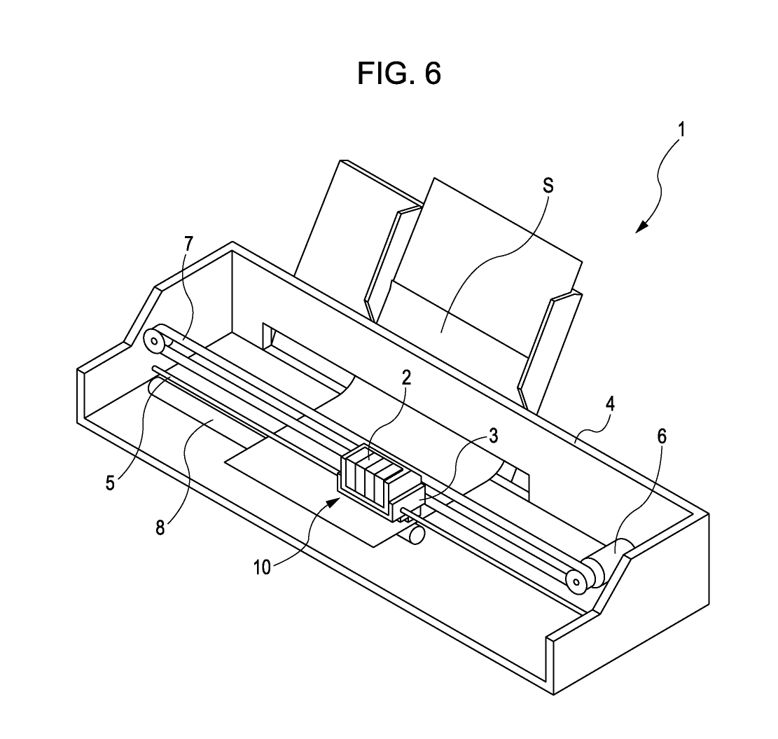

Further, at the lower end of each of the grooves 53 in the vertical direction, a liquid hold 54 is formed for storing liquid such as ink. With reference to FIGS. 4 and 5, the liquid hold 54 will be described below in detail.

As shown in the figures, the liquid hold 54 is formed as a recessed portion at the lower end of each groove 53 in the vertical direction. Specifically, the liquid hold 54 is defined by a wall 55 erected at the lower end of the groove 53, side walls 56a, 56b of the groove 53 and a bottom surface 57 of the groove 53 (a part of the reinforcement member 60 that is exposed to the groove 53), each of which serves as a wall of the recessed portion.

Here, the ingress of liquid such as ink into the interface between the head case 50 and each end face 61 of the reinforcement member 60 which is exposed from the head case 50 may reach the interface between the reinforcement member 60 which is exposed to the bottom surface of the groove 53 and side wall 56a (56b) of the groove 53. Even if ink enters the housing 51 via the interface between the reinforcement member 60 and the head case 50, ink reaches the groove 53, flows down the surface of the groove 53, and is collected in the liquid hold 54.

Since ink is collected in the liquid hold 54 in this manner, it is possible to prevent the liquid such as ink from depositing on the piezoelectric elements in the piezoelectric element unit or the wiring or other elements such as ICs on the circuit board 35, thereby preventing an operation failure or malfunction of those elements. As a result, according to this embodiment, the head 10 having the liquid hold 54 enables each element of the head 10 to be protected from liquid such as ink which enters the housing 51 of the head case 50 and achieve improved reliability.

Further, ink may enter the housing 51 of the head case 50 via the interface between the head case 50 and the flow passage member that is mounted on the head case 50. In such a case, the ink flows down the groove 53 and is collected in the liquid hold 54. Therefore, it is also possible to protect the elements in the housing 51, such as piezoelectric elements or the circuit board 35, from the ingress of ink.

In addition, in this embodiment, the opening of the liquid hold 54 is formed in a substantially trapezoidal shape, in which the bottom surface of the groove 53 is a shorter side. That is, as shown in the plan view, the opening formed by the wall 55, side walls 56a, 56b, and the bottom surface 57 has a substantially trapezoidal shape and the bottom surface 57 serves as a shorter side. With this substantially trapezoidal opening of the liquid hold 54, the angle θ₁ formed between the bottom surface 57 and the side wall 56a or 56b is an obtuse angle.

Since the angle θ₁ is obtuse, the ink held in the liquid hold 54 is prevented from flowing upward along the interface between the bottom surface 57 and the side wall 56a or 56b by the force of surface tension. This is because of the fact that, as the angle increases, the surface tension decreases and the upward flow of ink along the interface is less likely to occur. Therefore, by forming an obtuse angle at the angle θ₁ of the liquid hold 54, the ink held in the liquid hold 54 can be prevented from flowing out of the liquid hold 54 via the interface between the bottom surface 57 and the side wall 56a or 56b, thereby protecting the elements included in the head body 40 with a high reliability.

Further, an opening edge 58 of the liquid hold 54 is rounded. By forming a rounded opening edge 58, the ink held in the liquid hold 54 can be further prevented from flowing out of the liquid hold 54. For example, as shown in FIG. 5, by forming an opening edge 58 of the wall 55 in a rounded shape, the opening edge 58 of the wall 55 is opened away from the side wall 56a, which brings about a result similar to that in the case where the angle θ₁ is obtuse, thereby decreasing the surface tension of the ink in proximity of the opening edge 58 and preventing the ink from flowing out of the liquid hold 54.

The above described recording head 10 is configured such that, when ejecting ink droplets, the piezoelectric elements and the vibration plate 15 deform to change the volume of the pressure generating chambers 11 and eject ink droplets from specified nozzle openings 13. Specifically, when ink is supplied from an ink cartridge (not specifically shown) through ink supply channels 33 to the manifolds 18, ink is distributed to the respective pressure generating chambers 11 through the ink supply channels 19. In use, a voltage is applied to the piezoelectric elements to contract the piezoelectric elements. This causes the vibration plate 15 to be deformed with the piezoelectric elements, thereby increasing the volume of the pressure generating chambers 11 to cause the ink to be drawn into the pressure generating chambers 11. When the pressure generating chambers 11 and the nozzle orifices 13 are filled with ink, a voltage applied to the electrodes of the piezoelectric elements is released in response to recording signals supplied via the wiring substrate. Then, the piezoelectric elements expand and return to the original state, and the vibration plate 15 also returns to the original state. As a result, the volume of the pressure generating chambers 11 decreases, thereby increasing the pressure in the pressure generating chambers 11 to cause the ink to be ejected from the nozzle orifices 13.

### Other Embodiments

While an embodiment of the invention has been described, the invention should not be limited to the above described embodiment. For example, the liquid hold 54 is not limited to the configuration as described above, and may have any configuration for receiving ink that flows down the groove 53. For example, the groove 53 may have an inclined surface which slopes down toward the bottom surface 57 of the groove 53 at the lower end of the groove 53 to form a liquid hold. In this case, the ink which flows down the groove 53 is also held in the lower side of the inclined surface, therefore ink is prevented from being leaked out from the liquid hold 54.

Further, while the reinforcement member 60 to improve the rigidity of the head case has been described as an example of a metal member, a metal member may be provided for any purpose. For example, the effect of the invention can be achieved when a metal member is integrally molded in the head case 50 as a medium to transfer the heat to ink that flows through the ink supplying channels 33 in the head case 50.

In the above mentioned embodiment, the piezoelectric elements of the longitudinal vibration type are described as an example of pressure generating means. However, the configuration of the pressure generating means is not limited to the one described above. For example, piezoelectric elements of the flexural vibration type, static electric elements or heat generating elements may also be used.

The ink jet recording head according to the above embodiment serves to form a part of the recording head unit which is provided with the ink channel that is allowed to communicate with the cartridge, etc. and is loaded on the ink jet recording apparatus. FIG. 6 schematically shows an example of the ink jet recording apparatus.

As shown in FIG. 6, the liquid ejecting apparatus 1 according to an embodiment of the invention includes an ink jet recording head 10 in which an ink cartridge (liquid storage means) 2 is mounted, having liquid holds for storing the ink of different colors such as black (B), cyan (C), magenta (M), and yellow (y). The head 10 is loaded to the carriage 3, and the carriage 3 with the head 10 attached thereto is mounted to the carriage shaft 5 slidably movable in the axial direction, while the carriage shaft 5 is fixed to the apparatus body 4. When a driving force of the drive motor is transmitted to the carriage 3 through a plurality of gears and timing belts (not shown), the carriage 3 is moved along the carriage shaft 5. The apparatus body 4 includes a platen 8 arranged along the carriage shaft 5 and is configured such that a recording medium S, such as a paper sheet, which had fed out from the feeding unit (not shown) is transported on the platen 8.

While the ink jet recording head has been described as an example of the liquid ejecting head of the invention, the basic configuration of the liquid ejecting head is not limited to the one described above. The present invention covers the liquid ejecting head in general, and is applicable to the one that eject liquid other than ink. The liquid ejecting head includes, for example, various recording heads used for image recording apparatuses for printers, etc., color material ejecting heads used for the manufacturing of the color filters for liquid crystal displays, etc., organic EL displays, electrode material ejection heads used for forming electrode such as field emission displays (FED), and bioorganic ejection head used for manufacturing bio chips.

What is claimed is:

1. A liquid ejecting head comprising:
a liquid ejecting head body that ejects liquid droplets; and
a housing member formed of a resin with a metal member molded therein and having a housing for housing the liquid ejecting head body, the housing member includes:
a groove formed on the inner surface of the housing of the housing member and in which a part of the metal member is exposed; and
a liquid hold that holds liquid and is disposed at the end of the groove in the vertical direction.

2. The liquid ejecting head according to claim 1, wherein the liquid hold is a recessed portion which is recessed in the vertical direction.

3. The liquid ejecting head according to claim 2, wherein the recessed portion has an opening formed in a substantially trapezoidal shape, wherein a shorter side of the substantially trapezoidal shape is the bottom surface of the groove.

4. The liquid ejecting head according to claim 2, wherein the recessed portion has an opening with a rounded edge.

5. The liquid ejecting head according to claim 1, comprising:
a piezoelectric element forming member in which a plurality of piezoelectric elements are formed; and
a flow channel forming plate on which a vibration plate is attached such that distal ends of piezoelectric elements are attached to the vibration plate, and in which a plurality of pressure generating chambers is formed so as to communicate with nozzle orifices, wherein the piezoelectric element forming member is housed in the housing, and wherein the flow channel forming plate is mounted on the lower end surface of the housing member in the vertical direction.

6. A liquid ejecting apparatus comprising the liquid ejecting head according to claim 1.
